(19) United States
(12) Patent Application Publication
(10) Pub. No.: US 2010/0251294 A1
(43) Pub. Date: Sep. 30, 2010

(54) MOVING IMAGE PROCESSOR AND MOVING IMAGE PROCESSING METHOD

(75) Inventor: Shinichi OoI, Tokyo (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/580,102

(22) Filed: Oct. 15, 2009

(30) Foreign Application Priority Data
Mar. 31, 2009 (JP) 2009-086863

(51) Int. Cl. H04N 5/445

(52) U.S. Cl. 725/37; 345/629

(57) ABSTRACT

According to one embodiment, a moving image processor includes a receiver, a storage module, a rendering module, an overlay module, and an output module. The receiver receives moving image data. The storage module stores image data as a template of a user interface screen. The rendering module generates bitmap data representing the user interface screen, through which input is received, based on the image data stored in the storage module. The overlay module overlays the bitmap data representing the user interface screen on the moving image data. The output module outputs the moving image data on which the bitmap data is overlaid.

### CROSS-REFERENCE TO RELATED APPLICATIONS

This application is based upon and claims the benefit of priority from Japanese Patent Application No. 2009-086863, filed Mar. 31, 2009, the entire contents of which are incorporated herein by reference.

### BACKGROUND

1. Field

One embodiment of the invention relates to a moving image processor and a moving image processing method for providing a user interface during the processing of moving image data.

2. Description of the Related Art

With the recent advancement of computer technologies, there has been an increasing tendency to provide various devices with various functions. For example, television receivers tend to have various functions as the digitalization of television broadcasting progresses.

Such a multifunctional television receiver needs a user interface to allow the user to use the functions. Accordingly, there have been proposed various technologies to provide a user interface suitable for the user.

For example, Japanese Patent Application Publication (KOKAI) No. 2004-5636 discloses a conventional user interface that is optimized according to user's operation. With this, it is possible to provide each user with a user interface suitable for his/her operation without customization.

The conventional user interface is provided as a combination of text data and vector data, and is displayed on an input moving image data even in a multicolor television receiver with high resolution. Accordingly, user demand is not for such a user interface but rather for a user interface using rich graphics, preferably with motion, such as, for example, animation.

With a web browser installed on a personal computer (PC) or the like, a graphical user interface tends to be provided using Flash (registered trademark). This type of user interface can be designed so that the user is interested in using it. The graphical user interface, however, causes the rendering engine for display control to occupy areas in the web browser. As a result, it is difficult to display the graphical user interface overlaid on other content such as moving image data.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a signal processing system of a digital television (TV) broadcast display device according to an embodiment of the invention;

FIG. 2 is an exemplary block diagram of software and hardware configuration of the digital TV broadcast display device to display a graphical user interface (GUI) in the embodiment;

FIG. 3 is an exemplary schematic diagram of GUI screen data generated by an on-screen display (OSD) signal generator of the digital TV broadcast display device in the embodiment;

FIG. 4 is an exemplary schematic diagram of display image GUI data generated in response to a request by a display image rendering engine of the digital TV broadcast display device in the embodiment;

FIG. 5 is an exemplary schematic diagram of a menu screen to select a display image GUI in the embodiment;

FIG. 6 is an exemplary schematic diagram of a display screen including a GUI and a display image GUI displayed on a liquid crystal display (LCD) panel according to a conventional technology; and

FIG. 7 is an exemplary flowchart of the operation of the digital TV broadcast display device to display a television (TV) screen including a GUI in the embodiment.

### DETAILED DESCRIPTION

Various embodiments according to the invention will be described hereinafter with reference to the accompanying drawings. In general, according to one embodiment of the invention, a moving image processor comprises a receiver, a storage module, a rendering module, an overlay module, and an output module. The receiver is configured to receive moving image data. The storage module is configured to store image data as a template of a user interface screen. The rendering module is configured to generate bitmap data representing the user interface screen, through which input is received, based on the image data stored in the storage module. The overlay module is configured to overlay the bitmap data representing the user interface screen on the moving image data. The output module is configured to output the moving image data on which the bitmap data is overlaid.

According to another embodiment of the invention, there is provided a moving image processing method applied to a moving image processor comprising a storage module configured to store image data as a template of a user interface screen. The moving image processing method comprises: a receiver receiving moving image data; a rendering module generating bitmap data representing the user interface screen, through which input is received, based on the image data stored in the storage module; an overlay module overlaying the bitmap data representing the user interface screen on the moving image data; and an output module outputting the moving image data on which the bitmap data is overlaid.

In the following embodiments, the moving image processor is described by way of example as being applied to a digital television (TV) broadcast display device.

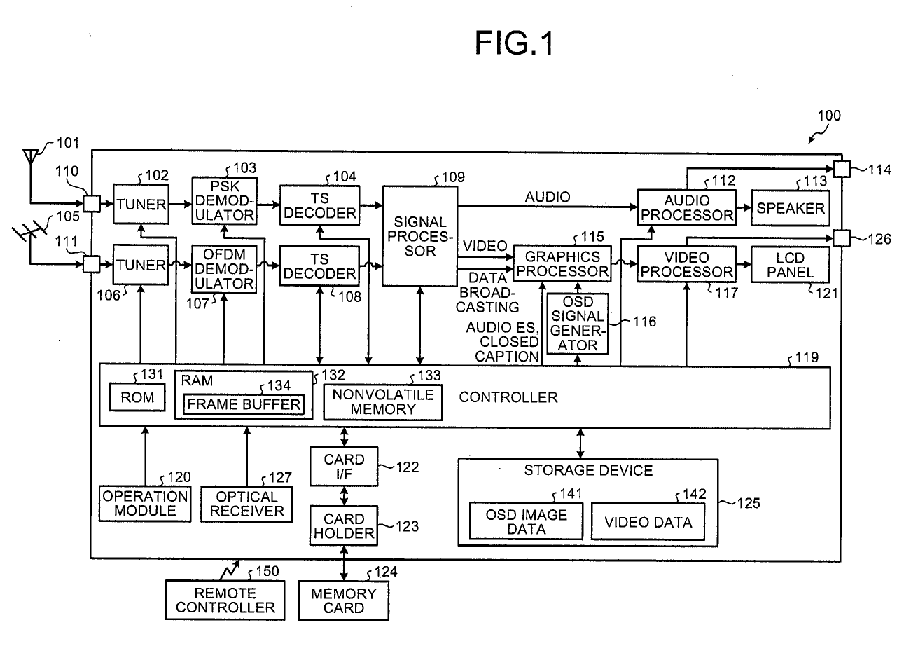

A description will be given of a hardware configuration of a digital TV broadcast display device 100 according to an embodiment of the present invention. FIG. 1 is a block diagram of a signal processing system of the digital TV broadcast display device 100.

As illustrated in FIG. 1, when an antenna 101 for receiving broadcast satellite/communication satellite (BS/CS) digital broadcasting receives a satellite digital TV broadcast signal, the broadcast signal is fed via an input terminal 110 to a tuner 102 for satellite digital broadcasting.

According to a control signal from a controller 119, the tuner 102 selects a desired channel, and then outputs a broadcast signal from the selected channel to a phase shift keying (PSK) demodulator 103.

The PSK demodulator 103 demodulates the broadcast signal received from the tuner 102 according to a control signal from the controller 119. Thus, the PSK demodulator 103 acquires a transport stream (TS) containing a desired program, and outputs it to a TS decoder 104.

The TS decoder 104 performs TS decoding on a multiplexed TS signal according to a control signal from the controller 119. The TS decoder 104 also depacketizes digital video and audio signals of the desired program to obtain a packetized elementary stream (PES). The TS decoder 104 then outputs the PES to an system target decoder (STD) buffer (not illustrated) in a signal processor 109. In addition, the TS decoder 104 sends section information transmitted through digital broadcasting to a section processor (not illustrated) in the signal processor 109.

On the other hand, when an antenna 105 for receiving digital terrestrial broadcasting receives a digital terrestrial TV broadcast signal, the broadcast signal is fed via an input terminal 111 to a tuner 106 for digital terrestrial broadcasting.

According to a control signal from the controller 119, the tuner 106 selects a desired channel, and outputs a broadcast signal from the selected channel to an orthogonal frequency division multiplexing (OFDM) demodulator 107.

The OFDM demodulator 107 demodulates the broadcast signal received from the tuner 106 according to a control signal from the controller 119. Thus, the OFDM demodulator 107 acquires a transport stream containing a desired program, and outputs it to a TS decoder 108.

The TS decoder 108 performs TS decoding on a multiplexed TS signal according to a control signal from the controller 119. The TS decoder 108 also depacketizes digital video and audio signals of the desired program to obtain a PES. The TS decoder 108 then outputs the PES to the STD buffer in the signal processor 109. In addition, the TS decoder 108 sends section information transmitted through digital broadcasting to the section processor in the signal processor 109.

While a user is viewing a TV program, the signal processor 109 selectively performs predetermined digital signal processing on the digital video and audio signals received from the TS decoder 104 and those received from the TS decoder 108. Then, the signal processor 109 outputs the video signal to a graphics processor 115 and the audio signal to an audio processor 112.

The controller 119 receives various types of data for obtaining a program processed by the section processor in the signal processor 109, electronic program guide (EPG) information, program attribute information such as program category, video, audio, closed caption information such as program specific information (PSI) and service information (SI), and the like. The EPG information and the program attribute information (program category, etc.) are stored in a nonvolatile memory 133 and updated as needed. These pieces of information stored in the nonvolatile memory 133 are used to display a program guide, search a program, or the like.

An event information table (EIT) in the SI contains an audio elementary stream (ES) and closed caption ES related information. The digital TV broadcast display device 100 is capable of performing search based on the audio ES and closed caption ES related information and displaying the search result.

To display EPG or closed captions, the controller 119 generates image data of EPG or closed captions based on the input information, and outputs the image data to the graphics processor 115.

Besides, the controller 119 has the function of controlling the recording and scheduled or timer recording of a program. When a user programs the recording of a program, the controller 119 displays EPG information on, for example, a liquid crystal display (LCD) panel 121. Having received an input from the user through a remote controller 150 or the like, the controller 119 stores information specified by the user in the nonvolatile memory 133. Thus, the controller 119 controls the tuners 102 and 106, the PSK demodulator 103, the OFDM demodulator 107, the TS decoders 104 and 108, a storage device 125, and the signal processor 109 so that a specified program is to be recorded during a specified time period.

From the section information received from the TS decoder 104 (108), the section processor in the signal processor 109 outputs to the controller 119 various types of data for obtaining a program, EPG information, program attribute information such as program category, closed caption information such as PSI and SI, and the like.

While a program is being recorded, the signal processor 109 selectively performs predetermined digital signal processing on the digital video and audio signals received from the TS decoder 104 and those received from the TS decoder 108. Then, the controller 119 stores the signals obtained by the signal processor 109 in the storage device (for example, HDD) 125 as video data 142. While a recorded program is being reproduced, the signal processor 109 outputs the video data 142 read from the storage device 125 through the controller 119 to the graphics processor 115 and the audio processor 112.

In the above example, the signal processor 109 performs AV decoding such as MPEG on digital video and audio signals. After the decoding, the signal processor 109 stores, directory or after performing predetermined digital signal processing such as recompression on the digital video and audio signals, the digital video and audio signals in the storage device 125. Thus, a program is recorded on the storage device 125. However, it is not so limited. Although not illustrated, a program may be recorded by, for example, dividing a TS output from the PSK demodulator 103 or the OFDM demodulator 107 into partials to be recorded.

The graphics processor 115 multiplexes the following signals: (1) a digital video signal fed from an AV decoder (not illustrated) in the signal processor 109, (2) an on-screen display (OSD) signal generated by an OSD signal generator 116, (3) image data of data broadcasting, and (4) EPG, closed caption signal, display image graphical user interface (GUI) data generated by the controller 119. The graphics processor 115 outputs the synthesized signals to a video processor 117.

The term “display image GUI data” as used herein refers to GUI data generated by an OSD image rendering engine, which will be described later, implemented in the controller 119. In the embodiment, the display image GUI data is applied to display of information on a program currently being received by the digital TV broadcast display device 100 (for example, the channel of the program, the channel logo, the title of the program, etc.), display of the volume adjustment bar, and the like. The detail will be described later.

The graphics processor 115 of the embodiment overlays two types of GUI data on a digital video signal. The two types of GUI data include GUI data generated by the OSD signal generator 116 and display image GUI data generated by the controller 119.

The GUI data generated by the OSD signal generator 116 is of basically the same as conventional GUI data. In the embodiment, the GUI data is used to display input switch and the like. This GUI data is assumed to be formed of a combination of font data representing letters or characters and vector data representing a frame and the like. Such a GUI generated by a combination of display data results in less processing load related to display on the digital TV broadcast display device 100. Further, the use of the GUI data can reduce the burden on a GUI designer. On the other hand, it is difficult to provide display with motion by the GUI data, i.e., the GUI data is difficult to be designed.

To display a close-captioned program with closed captions, the graphics processor 115 overlays closed caption information from the controller 119 on a video signal under the control of the controller 119.

The storage device 125 stores a plurality of types of OSD image data 141 each used as a template upon generation of display image GUI data.

A random access memory (RAM) 132 comprises a frame buffer 134. The frame buffer 134 is used to temporarily store display image GUI data generated from OSD image data. The display image GUI data temporarily stored in the frame buffer 134 is overlaid on a video signal by the graphics processor 115.

The digital video signal output from the graphics processor 115 is input to the video processor 117. The video processor 117 converts the input digital video signal to an analog video signal in a format displayable on the LCD panel 121. The video processor 117 then outputs the analog video signal to the LCD panel 121 to display the video thereon. Besides, the video processor 117 may convert the input digital video signal to an analog video signal in a format displayable on an external display device (not illustrated), and output it to the external display device via an output terminal 126 to display the video thereon.

The audio processor 112 converts the input digital audio signal to an analog audio signal in a format reproducible by a speaker 113. The audio processor 112 then outputs the analog audio signal to the speaker 113 to reproduce the audio. Besides, the audio processor 112 may convert the input digital audio signal to an analog audio signal in a format reproducible by an external audio output device (not illustrated), and output it to the external audio output device via an output terminal 114 to reproduce the audio.

The controller 119 controls the overall operation of the digital TV broadcast display device 100 including the operation of receiving various types of signals as described above. The controller 119 comprises a built-in central processing unit (CPU). Upon receipt of operation information sent from the remote controller 150 or the like via an optical receiver 127, the controller 119 controls the respective modules to operate according to the operation information such as to switch channels.

The controller 119 performs this control using mainly a read only memory (ROM) 131, the RAM 132, and the nonvolatile memory 133 such as a flash memory. The ROM 131 stores a control program executed by the CPU. The RAM 132 provides a work area to the CPU. The nonvolatile memory 133 stores various types of setting information, control information, program information, and the like. The control program includes a program for generating display image GUI data and a TV application for displaying a received program.

The controller 119 is connected to an operating module 120, and receives an input to the digital TV broadcast display device 100 from the operation module 120.

Further, the controller 119 is connected via a card interface (I/F) 122 to a cardholder 123. With this, the controller 119 can communicate data with a memory card 124 connected to the card holder 123 through the card I/F 122.

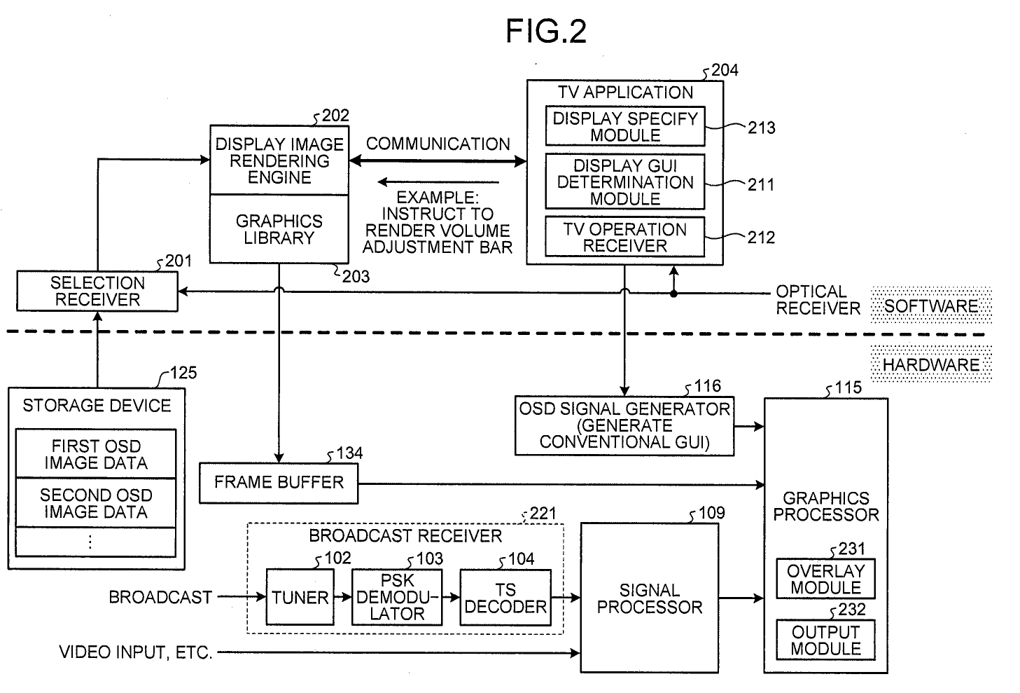

In the following, a description will be given of a configuration of the digital TV broadcast display device 100 for displaying a GUI based on display image GUI data. FIG. 2 is a block diagram of software and hardware configuration of the digital TV broadcast display device 100 to display a GUI.

As illustrated in FIG. 2, the digital TV broadcast display device 100 comprises, as software configuration, a selection receiver 201, a display image rendering engine 202, a graphics library 203, and a TV application 204.

The digital TV broadcast display device 100 further comprises, as hardware configuration, the storage device 125, the frame buffer 134, the OSD signal generator 116, a broadcast receiver 221, the signal processor 109, the graphics processor 115.

The broadcast receiver 221 comprises the tuner 102, the PSK demodulator 103, and the TS decoder 104. The broadcast receiver 221 receives a broadcast, and outputs it to the signal processor 109 as a video signal.

The TV application 204 comprises a TV operation receiver 212, a display GUI determination module 211, and a display specify module 213. The TV application 204 controls various types of software and hardware to output a TV broadcast from the digital TV broadcast display device 100 as video and audio. Other controls are performed in a conventional manner, and therefore, only the control related to display GUI by the TV application 204 will be described below.

The TV operation receiver 212 receives the input of operation information from the optical receiver 127. The operation information indicates operation on the digital TV broadcast display device 100 to, for example, switch display on the digital TV broadcast display device 100, adjust the audio volume output from the digital TV broadcast display device 100, or the like.

The display GUI determination module 211 determines a GUI to be displayed based on the operation information received by the TV operation receiver 212. More specifically, the display GUI determination module 211 determines whether the operation indicated by the operation information corresponds to operation represented by a conventional GUI generated by the OSD signal generator 116 or operation represented by a display image GUI generated by the display image rendering engine 202.

The display specify module 213 specifies a GUI to be displayed based on the determination result of the display GUI determination module 211. When the display GUI determination module 211 determines to display a conventional GUI, the display specify module 213 of the embodiment instructs the OSD signal generator 116 to display a GUI related to the input operation information.

On the other hand, when the display GUI determination module 211 determines to display a display image GUI, the display specify module 213 instructs the display image rendering engine 202 to display a display image GUI related to the input operation information. Examples of the operation to display such a GUI include press of the volume button.

The OSD signal generator 116 generates conventional GUI screen data according to the instruction from the display specify module 213, and outputs it to the graphics processor 115.

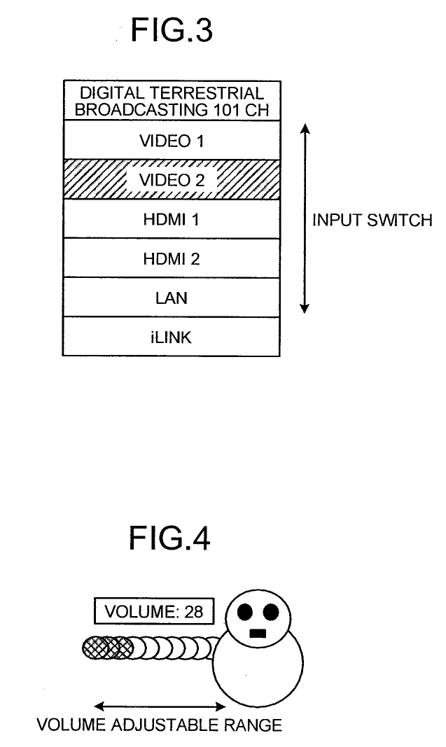

FIG. 3 illustrates an example of the GUI screen data generated by the OSD signal generator 116. As illustrated in FIG. 3, the OSD signal generator 116 of the embodiment generates GUI screen data for input switch. Through the display of this GUI screen, the digital TV broadcast display device 100 can receive an input to switch input information (broadcast, video data, etc.) displayed on the LCD panel 121. While the conventional GUI screen generated by the OSD signal generator 116 is described above as being used for input switch, this is by way of example and not of limitation. The conventional GUI screen may provide various types of information.

The display image rendering engine 202 generates bitmap data representing a display image GUI screen according to the instruction from the display specify module 213 of the TV application 204. The display image rendering engine 202 generates the bitmap data using the graphics library 203.

More specifically, the display image rendering engine 202 reads OSD image data stored in the storage device 125. The display image rendering engine 202 generates bitmap data representing a display image GUI screen based on the OSD image data. In this manner, the OSD image data serves as a template of the bitmap data to be generated.

Any rendering engine may be used as the display image rendering engine 202 as long as it generates rendering data of a display image GUI. The display image rendering engine 202 may be, for example, Flash Lite (registered trademark) or Flash Player (registered trademark).

FIG. 4 illustrates an example of bitmap data representing a display image GUI generated in response to a request by the display image rendering engine 202. With display image GUI data illustrated in FIG. 4, the current audio volume is indicated by the length of an arm of a character. That is, the display image GUI data illustrated in FIG. 4 is updated upon receipt of an input from the user to adjust the audio volume. The display image rendering engine 202 generates bitmap data representing a display image GUI screen each time an input is received to change the audio volume. The bitmap data indicates at least the audio volume changed by the input. The bitmap data is sent to the frame buffer 134, synthesized by the graphics processor 115, and displayed on the LCD panel 121.

Referring back to FIG. 2, the graphics library 203 is a graphics application programming interface (API) called by the display image rendering engine 202 for display on the LCD panel 121. The graphics library 203 of the embodiment is, for example, an extended DirectFrameBuffer (FB) so that it can be applied to the digital TV broadcast display device 100. The DirectFB is a graphics API implemented on a Linux Framebuffer Device. The use of the DirectFB can bring out a high level of rendering function of the hardware of the digital TV broadcast display device 100. This achieves smooth rendering at high speed.

More specifically, the graphics library 203 performs memory mapping for the frame buffer 134 in response to a request from the display image rendering engine 202. With this, display image GUI data is loaded into the frame buffer 134.

The storage device 125 stores first OSD image data, second OSD image data, third OSD image data, and fourth OSD image data. These pieces of OSD image data are used to generate display image GUI screen data. In the embodiment, display image GUI displayed on the digital TV broadcast display device 100 can be switched by changing the OSD image data to read.

The selection receiver 201 receives the input of selection information for a display image GUI from the optical receiver 127. The selection information indicates the type of a display image GUI screen selected by the user. In the following, a description will be given of a procedure until display image GUI data is selected.

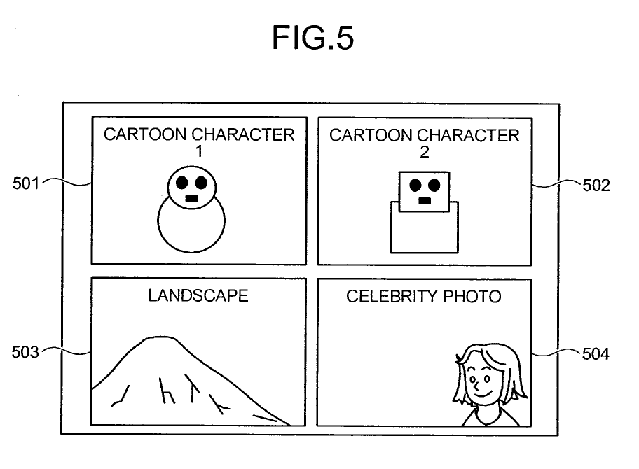

First, upon receipt of an input to select a display image GUI screen through the optical receiver 127, the digital TV broadcast display device 100 displays a menu screen as illustrated in FIG. 5. FIG. 5 illustrates an example of the menu screen to select a display image GUI. When the user selects one of four selection items from the menu screen using the remote controller 150 or the like, selection information is input to the selection receiver 201 through the optical receiver 127.

While, in the example of FIG. 5, cartoon characters and photos are displayed, it is not so limited. Not only still images without motion but also additional data may be used that indicates motion specifiable for the display image rendering engine 202. That is, the OSD image data includes data that specifies motion in addition to image data. For example, if Flash Lite (registered trademark) or Flash Player (registered trademark) is used as the display image rendering engine 202, Actionscript (registered trademark) may be used as the additional data. In such a case, image data to be used is not limited to a single piece, but a moving GUI can be generated using a plurality of pieces of image data and the additional data.

In this manner, the OSD image data stored in the storage device 125 may include image data and such additional data.

According to the selection information, the selection receiver 201 can specify which one of selection items 501 to 504 is selected by the user. Incidentally, the selection items 501 to 504 are associated with the first to fourth OSD image data stored in the storage device 125, respectively.

More specifically, upon receipt of selection information, the selection receiver 201 reads OSD image data associated with a selection item specified by the selection information from the storage device 125. The selection receiver 201 then outputs the OSD image data to the display image rendering engine 202. With this, a display image GUI screen corresponding to the selection item selected by the user is displayed. After that, a display image GUI screen is generated based on OSD image data specified by selection information.

The signal processor 109 receives a video signal received by the broadcast receiver 221 or video data stored in the storage device 125 via the controller 119. In other words, the signal processor 109 serves as a receiver that receives moving image data.

The graphics processor 115 comprises an overlay module 231 and an output module 232, and generates a video signal to be fed to the video processor 117.

The overlay module 231 overlays, on the digital video signal received from the signal processor 109, either or both display image GUI data stored in the frame buffer 134 and an OSD signal (a conventional GUI screen) generated by the OSD signal generator 116.

The output module 232 outputs the video signal, on which at least one of the display image GUI data or the conventional GUI screen is overlaid, to the LCD panel 121 through the video processor 117. The LCD panel 121 displays the video signal including the GUI.

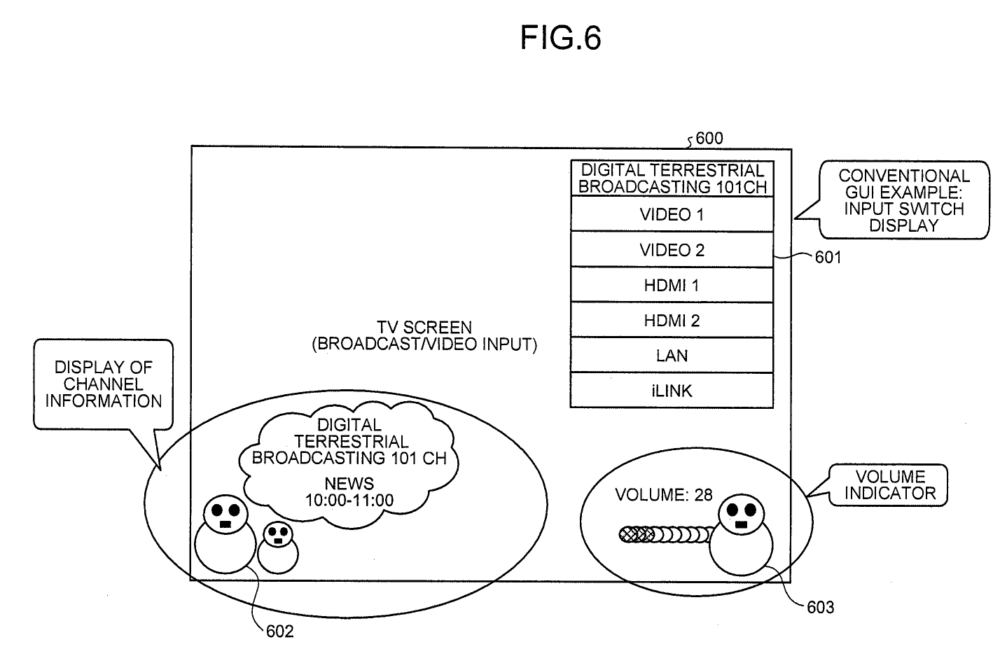

FIG. 6 illustrates an example of a display screen including the GUIs as described above. As illustrated in FIG. 6, the LCD panel 121 displays a conventional GUI 601, a first display image GUI 602, and a second display image GUI 603 overlaid on a TV screen 600.

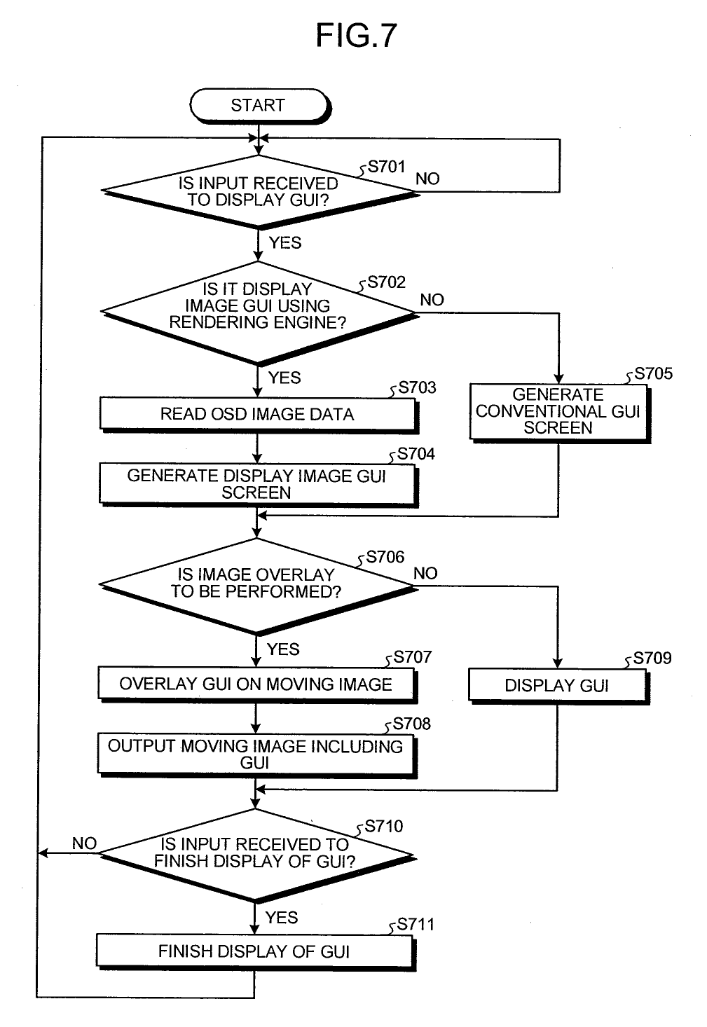

A description will now be given of the operation of the digital TV broadcast display device 100 to display a TV screen including a GUI. FIG. 7 is a flowchart of the operation of the digital TV broadcast display device 100 to display a TV screen including a GUI.

First, the TV operation receiver 212 determines whether an input is received through the optical receiver 127 that requires the display of a GUI (S701). Having determined that such an input is not received (No at 5701), the TV operation receiver 212 repeats the process at S701.

On the other hand, when the TV operation receiver 212 determines that an input is received that requires the display of a GUI (Yes at S701), the display GUI determination module 211 determines whether the GUI to be displayed is a display image GUI using a rendering engine (S702).

Having determined that the GUI to be displayed is a display image GUI using a rendering engine (Yes at S702), the display GUI determination module 211 instructs the display image rendering engine 202 to render a GUI image corresponding to the input. In response to the instruction, the display image rendering engine 202 reads from the storage device 125 OSD image data selected in advance by the selection receiver 201 (S703). The display image rendering engine 202 then calls the graphics library 203 based on the OSD image data, and generates a display image GUI screen corresponding to the input (performs memory mapping) on the frame buffer 134 (S704).

On the other hand, having determined that the GUI to be displayed is not a display image GUI using a rendering engine (No at S702), the display GUI determination module 211 instructs the OSD signal generator 116 to create a GUI image corresponding to the input. In response to the instruction, the OSD signal generator 116 generates a conventional GUI screen corresponding to the input (S705).

Thereafter, the graphics processor 115 determines whether to overlay a moving image on the display of the GUI (S706). When the graphics processor 115 determines to overlay a moving image on the display of the GUI (Yes at S706), the overlay module 231 overlays at least one of the conventional GUI and the display image GUI on the moving image or video signal (S707).

The output module 232 outputs the video signal (moving image data), on which at least one of the conventional GUI and the display image GUI is overlaid, to the LCD panel 121 to display the moving image data including the GUI (S708).

On the other hand, when the graphics processor 115 determines not to overlay a moving image on the display of the GUI (No at 5706), the output module 232 outputs the display image GUI or the GUI screen to the LCD panel 121 to display either one of them (S709).

After the process at S708 or 5709, the TV operation receiver 212 determines whether an input is received to finish the display of the GUI (S710). When the TV operation receiver 212 determines that such an input is not received (No at S710), the display of the GUI continues, and the process returns to S701. After that, if an input is received that requires the display of another GUI, a plurality of GUIs are displayed on the TV screen. With this, a conventional GUI and a display image GUI may be displayed together.

When the TV operation receiver 212 determines that an input is received to finish the display of the GUI (Yes at S710), the display of the GUI is finished (S711), and the process returns to S701.

With the operation described above, video, on which at least one of a display image GUI and a conventional GUI is overlaid, can be displayed.

In the embodiment, an example is explained in which a volume adjustment bar and program information are displayed as display image GUI data to allow the user to provide input related to them. However, the display image GUI data is not limited to such a volume adjustment bar and program information, but may be applied to display of various types of information. Example of information to be displayed include a program guide, recorded program information, information for specifying various other settings of the receiver.

While the moving image processor of the embodiment is described above as a digital TV broadcast display device by way of example, it is not limited to such a digital TV broadcast display device. The moving image processor may be any device that processes video data such as a video recorder that records digital broadcast, a mobile terminal capable of displaying a TV program of one-segment broadcasting, a PC capable of displaying a TV program of digital terrestrial broadcasting, and the like.

As set forth hereinabove, according to the embodiment, the digital TV broadcast display device 100 uses a display image GUI, and thereby is capable of providing an interface using rich graphics and an interface using moving graphics. Thus, the user can easily and visually recognizes the content of the interface. Namely, it is possible to provide a user friendly interface.

Moreover, according to the embodiment, OSD image data may be generated for a predetermined display image rendering engine to design a display image GUI. Design environment and tools are generally prepared for commonly used or distributed rendering engines such as, for example, Flash Lite (registered trademark) and Flash Player (registered trademark). This increases the freedom and efficiency of design compared to conventional GUIs. Thus, it is possible to design a GUI according to a request from the user.

Furthermore, according to the embodiment, the digital TV broadcast display device 100 can display both display image GUI and conventional GUI. Thus, it is possible to provide the user with a GUI depending on the purposes.

Still further, according to the embodiment, the digital TV broadcast display device 100 selectively uses a display image GUI and a conventional GUI. Thus, it is possible to provide a GUI to suit the needs or preferences of the user as well as to reduce the burden on a GUI designer.

Still further, according to the embodiment, the digital TV broadcast display device 100 provides a display image GUI based on OSD image data selected by the selection receiver 201. Thus, it is possible to provide a GUI to suit the needs or preferences of the user.

While, in the embodiment, OSD image data is described as being stored in advance in the storage device 125, it may be provided as being stored in a computer-readable storage medium, such as a compact disk read-only memory (CD-ROM), a flexible disk (FD), a compact disc-recordable (CD-R), or a digital versatile disc (DVD), and loaded therefrom into the storage device 125 using a storage medium reader (not illustrated). The OSD image data may also be stored in a computer connected via a network such as the Internet so that it can be downloaded therefrom via the network.

Besides, a computer program (hereinafter, “video processing program) may be executed on a computer to realize the same function as the digital TV broadcast display device 100 of the embodiment. The video processing program may be provided as being stored in advance in ROM or the like.

The video processing program may also be provided as being stored in a computer-readable storage medium, such as CD-ROM, FD, CD-R, or DVD, in an installable or executable format, and stored therefrom in the nonvolatile memory 133 using a storage medium reader (not illustrated).

The video processing program may also be stored in a computer connected via a network such as the Internet so that it can be downloaded therefrom via the network. The video processing program may also be provided or distributed via a network such as the Internet.

The video processing program includes modules that implement the constituent elements described above (the selection receiver 201, the display image rendering engine 202, the graphics library 203, and the TV application 204). As hardware, the CPU loads the control program from the ROM into the main memory and executes it. Thus, the selection receiver 201, the display image rendering engine 202, the graphics library 203, and the TV application 204 are implemented on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A moving image processor comprising:
a receiver configured to receive moving image data;
a storage module configured to store image data as a template of a user interface screen;
a rendering module configured to generate bitmap data representing the user interface screen, through which input is received, based on the image data stored in the storage module;
an overlay module configured to overlay the bitmap data representing the user interface screen on the moving image data; and
an output module configured to output the moving image data on which the bitmap data is overlaid.

2. The moving image processor of claim 1, further comprising a display generation module configured to generate user interface display data to be displayed as a user interface screen from a combination of pieces of display data including character data, wherein
the overlay module is configured to overlay the user interface display data generated by the display generation module on the moving image data.

3. The moving image processor of claim 2, further comprising:
a receiver configured to receive input information indicating user input; and
a determination module configured to determine whether to generate the bitmap data or the user interface display data.

4. The moving image processor of claim 2, wherein the output module is configured to output the moving image data on which both the bitmap data and the user interface display data are overlaid.

5. The moving image processor of claim 1, wherein the storage module is configured to store a plurality of pieces of image data, the moving image processor further comprising:
a selection receiver configured to receive input to select one of the pieces of image data stored in the storage module, and wherein
the rendering module is configured to generate the bitmap data based on the one of the pieces of image data selected by the input.

6. The moving image processor of claim 1, further comprising a graphics library wherein
the rendering module is configured to call the graphics library to generate the bitmap data.

7. A moving image processing method applied to a moving image processor comprising a storage module configured to store image data as a template of a user interface screen, the moving image processing method comprising:
a receiver receiving moving image data;
a rendering module generating bitmap data representing the user interface screen, through which input is received, based on the image data stored in the storage module;
an overlay module overlaying the bitmap data representing the user interface screen on the moving image data; and
an output module outputting the moving image data on which the bitmap data is overlaid.
